(19) United States
(12) Patent Application Publication
(10) Pub. No.: US 2008/0168497 A1
(43) Pub. Date: Jul. 10, 2008

(54) METHODS, SYSTEMS, AND COMPUTER PROGRAM PRODUCTS FOR PROVIDING INTERACTIVE ELECTRONIC PROGRAMMING GUIDE SERVICES

(75) Inventor: Matthew Mitchem, Decatur, GA (US)

Correspondence Address: CANTOR COLBURN LLP - BELLSOUTH, 20 Church Street, 22nd Floor, Hartford, CT, 06103, US

(73) Assignee: BELLSOUTH INTELLECTUAL PROPERTY CORPORATION, Wilmington, DE (US)

(21) Appl. No.: 11/619,664

(22) Filed: Jan. 4, 2007

(51) Int. Cl. G06F 3/01

(52) U.S. Cl. 725/42

(57) ABSTRACT

A method, system, and computer program product for implementing interactive electronic programming guide (EPG) services are provided. The method includes determining an activity relating to a program listed on an EPG and, upon determining that an advertisement exists for the program, retrieving the advertisement and instructing EPG software to insert the advertisement within an allotted advertisement space provided by the EPG software.

### BACKGROUND

The present invention relates generally to Internet Protocol (IP)-based programming services, and more particularly, to methods, systems, and computer program products for providing interactive electronic programming guide services.

Current electronic programming guides (EPGs) display current and future television programs by title, and in some instances provide textual descriptions of the program within a display panel at a content viewing device. This textual information provides a brief summary (e.g., typically one or two sentences) about the program. In addition, EPGs provide viewers with options for selecting a program from the EPG to view and/or record to a digital recording device (DVR).

Oftentimes, members of the viewing public become intolerant when their programming is continuously interrupted by advertising. As a result, it is not uncommon for users of content viewing devices to bypass commercials by, e.g., changing channels, using a recording device and service such as Tivo® to skip over commercials, or simply walling out of the room. Clearly, this is not an ideal situation for advertisers, nor is it ideal for programming service providers that rely on advertising revenues. In view of this, advertisers have been seeking new ways to reach consumers. For example, some advertisers pay a premium to have their products appear within the actual programming itself.

Not all advertising, however, is considered unappealing to a consumer. The timing of the ad placement can play an important role in a successful advertisement, e.g., the advertisement is presented to a consumer who, at the time, is interested in the product being advertised. Thus, carefully timed advertisement placement can be advantageous for the advertiser and the consumer.

It would be desirable to provide an alternative means of advertising and related services that targets a particular audience.

### BRIEF SUMMARY OF THE INVENTION

Exemplary embodiments include a method, system, and computer program device for providing interactive electronic programming guide (EPG) services. The method includes determining an activity relating to a program listed on an EPG and, upon determining that an advertisement exists in association with the program, retrieving the advertisement and instructing EPG software to insert the advertisement within an allotted advertisement space provided by the EPG software.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram depicting a system upon which electronic programming guide (EPG) services may be implemented in exemplary embodiments;

FIG. 2 is a flow diagram describing a process for implementing the EPG services in exemplary embodiments; and

FIG. 3 depicts an EPG display screen with sub-panels providing targeted advertising and related information in exemplary embodiments.

The detailed description explains the exemplary embodiments, together with advantages and features, by way of example with reference to the drawings.

### DETAILED DESCRIPTION OF EXEMPLARY EMBODIMENTS

In accordance with exemplary embodiments, electronic programming guide (EPG) services are provided. The EPG services provide customized and targeted advertising and related interactive capabilities for digital content receiving devices (also referred to as content viewing devices) that receive content via, e.g., cable, satellite, IPTV and/or terrestrial sources. The targeted advertising may be implemented using a variety of techniques, such as data stream sampling, behavior profiling, demographic analyses, etc. The interactive capabilities are enabled via the EPG services to assist users of the digital content receiving devices in acquiring additional information regarding a program listing within an EPG guide, purchasing and/or downloading a program listed in the EPG guide, purchasing a product/service advertised via the EPG, and/or sharing program information with one or more other users via, e.g., a graphical user interface provided by the EPG services. While the embodiments are described herein as relating to electronic programming guides, it will be understood that the scope of these embodiments is not so limited. For example, the services described herein may apply to, e.g., Now Playing Lists or similar types of programming guides.

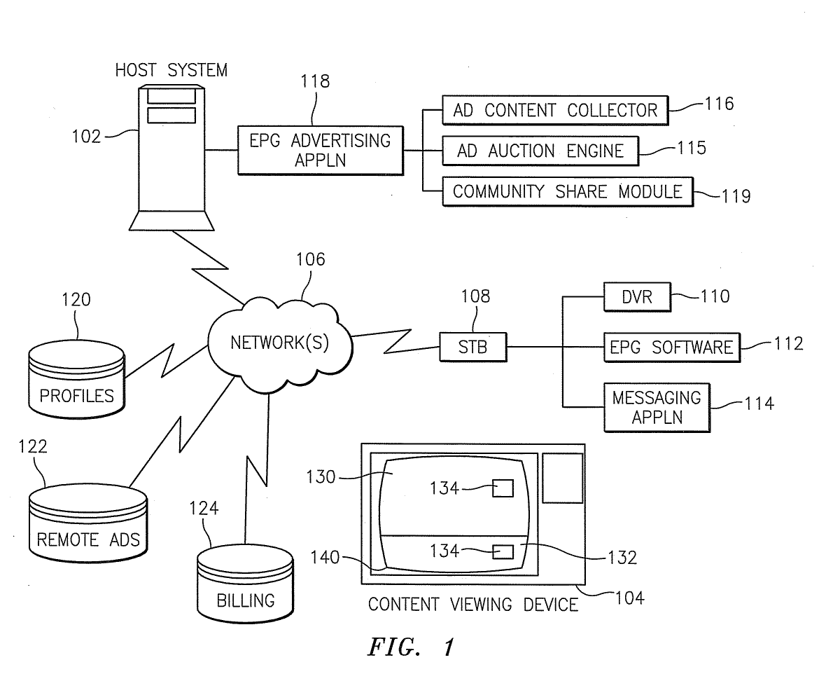

Turning now to FIG. 1, a system upon which the EPG services may be implemented in accordance with exemplary embodiments will now be described. The system of FIG. 1 includes a host system 102 in communication with a content viewing device 104 via one or more networks 106. The host system 102 facilitates the EPG services described herein. The host system 102 may be an EPG provider enterprise, a content provider, or a combination thereof. For ease of illustration, host system 102 provides both programming content and EPG services.

In exemplary embodiments, host system 102 is implemented by a high-speed processing device that provides content to its customers (e.g., a user of content viewing device 104), such as television programs, premium programming services, video on demand content, and Internet/Web content (e.g., podcasts, streaming media, etc.), and EPGs, to name a few. In exemplary embodiments, this content is transmitted to customers via, e.g., a broadband connection over an Internet Protocol (IP)-based network (e.g., networks 106). EPGs provide information about current and future programming available via the host system's services. Programming information provided by the electronic programming guide may include, e.g., current and future program listings including program titles, primary actors/actresses, begin time, duration of program, a year in which the program was produced, and a brief text description of the program.

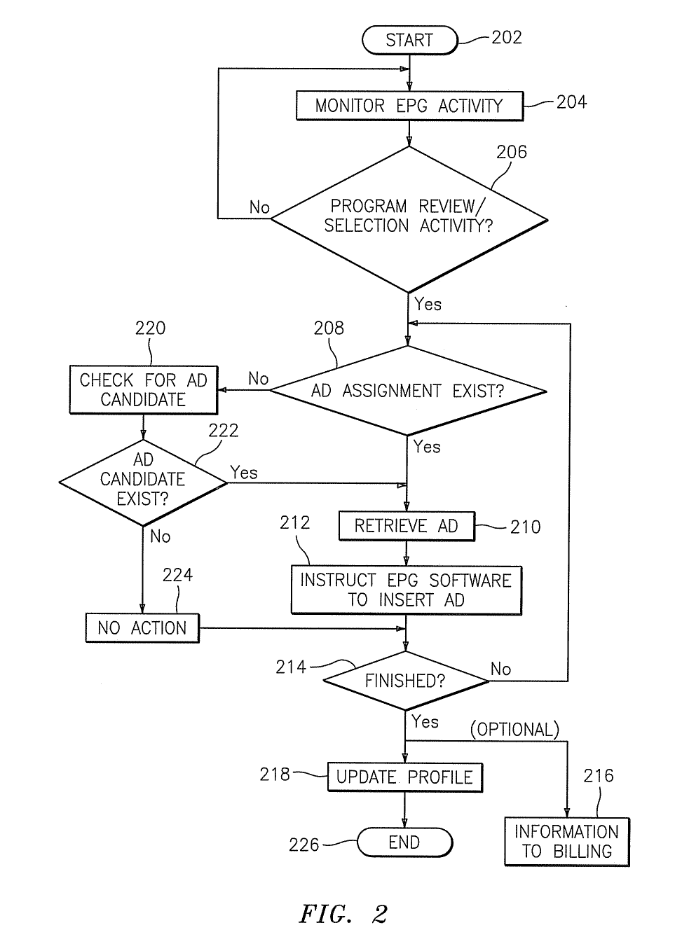

In exemplary embodiments, host system 102 executes one or more applications for implementing the EPG services described herein. These applications are collectively referred to as EPG advertising application 118. The EPG advertising application 118 and electronic programming services may be implemented as a single program executing on the host system 102, or may be separate physical components that interact via, e.g., an application programming interface or other technique. In exemplary embodiments, the EPG application 118 includes three components: an ad content collector 116, an auction engine 115, and a community share module 119. In alternative exemplary embodiments, a portion of the EPG advertising application 118 may execute locally on content viewing device 104. The functionality of the EPG services provided via the EPG advertising application 118 will be described further in FIG. 2.

Also included in the system of FIG. 1 are storage devices 120-124 that are communicatively coupled to the host system 102 over networks 106. Alternatively, one or more of the storage devices 120-124 may be in direct communication with the host system (e.g., via physical cabling or wireless means). In exemplary embodiments, storage device 120 stores customer profiles. These customer profiles may include statistical data relating to past customer behavior with respect to program viewing selections and related activities by users of content viewing devices. For example, a customer profile record may be generated for each user and may contain information, such as: past viewing and recording selections, the dates and times of these viewing and recording activities, the amount of time a user is active at a content viewing device, etc. This information may be useful in identifying customer interests, trends, and future behaviors. As indicated above, this statistical data may be acquired using various technologies. For example, on-demand viewing selections may be identified as the user selects/orders a premium program for viewing. Also, data stream sampling of the customer's service may provide useful information regarding whether the customer is active (i.e., via channel changes, etc.), as well as the times and selections made by the customer. Data stream sampling may be implemented, e.g., via the methods described in U.S. Pat. No. 6,983,478 “Method and System for Tracking Network Use” to Grauch et al., incorporated by reference herein or through other similar known methods. The customer profile record may then be updated periodically to reflect new or changing user behaviors. The EPG services may utilize data stored in the customer profile records in storage device 120 to identify the customer's interests for use in targeting specific advertisements to the customer as described herein.

In exemplary embodiments, storage device 122 stores advertisements received from entities that wish to provide advertisements to customers via the EPG services. For example, entities may include, but are not limited to, national or local product/service manufacturers, program provider entities (e.g., local or national broadcasting networks, cable service providers, etc.), and entities providing public service announcements (PSAs) or other information, to name a few. Advertisement subject matter may be directed to products or services, programming content, public service information, etc. Advertisements stored in storage device 122 may be directly deposited in the storage device 122 by the respective entities for inclusion in an allotted space provided by the EPG services (e.g., in EPG service panels 134 as described below).

Advertisements may be directly assigned to a particular EPG element or may be spontaneously determined via the EPG services. In exemplary embodiments, direct assignment of an advertisement may occur when an advertiser specifies a particular program, time, and/or demographic in which to display an advertisement. For example, an advertiser may request that their advertisement be displayed whenever a user scrolls over or selects a particular program, such as “Lost”, in the electronic program guide. If the ad space is available (e.g., no previous assignment made for the EPG service panel 134 of the particular program listing within the EPG guide), then the EPG advertising application 118 allocates the advertisement to the allotted space based upon these criteria. The advertisement may be stored in the remote ads storage device 122 or may be stored in memory at the host system 102 if desired. The advertisement is retrieved and provided to the EPG software of a targeted content viewing device at the appropriate time. In alternative embodiments, the advertisement may be encoded along with the EPG software data before transmission to the set top box 108 of the content viewing device 104 using, e.g., MPEG 2 protocols or similar means. In some embodiments of the invention, the user does not need to actually select the program from the EPG but just may be scrolling over different programs to receive program guide information. In other embodiments, the advertisement may change to a different advertisement and/or move to a different area of the viewing screen when the user actually selects a program from the program guide for more information, viewing, etc. so that the user may use the program guide to view more information about the program, select programs to record and view, etc. The advertisement may also be switched to a different advertisement when the user selects a program from the EPG because at that point more information is known about the user. For example, a user who happens to scroll over the program “Lost” in an EPG may or may not be interested in that program. However, a user who selects “Lost” from an EPG has at least a minimal amount of interest in the program “Lost” and therefore advertisers may desire to reach these interested users.

In exemplary embodiments, advertisement candidates include advertisements that may be provided by advertisers without identifying a specific program, time, and/or demographic. For example, while advertisers generally possess some insight as to their likely demographic audience, it may be that unexpected viewing behaviors reveal previously unknown interests. The EPG services enable advertisers to deposit advertisements in storage device 122 whereby ad content collector 116 determines where and when to allocate the advertisement with respect to the EPG software 112. The EPG advertising application 118 may include an analytic component that includes rules and criteria for determining appropriate target viewing devices for distributing the advertisement. For example, profile information may be analyzed to determine a target viewer's interests such as is described further in U.S. Pat. No. 6,718,551 to Swix et al. incorporated by reference herein and in other known targeted advertising methods and systems.

In addition, the EPG advertising application 118 and/or an advertiser may specify which activities (browsing a channel or program listed in the EPG, selecting the program to view/record, or simply activating the EPG software 112) may trigger the display of an advertisement.

In exemplary embodiments, storage device 124 stores billing information pertaining to customers (e.g., users of content viewing devices). The billing information in storage device 124 identify customers, or viewers, of content viewing devices 104 and may be accessed and updated to reflect e-commerce activities conducted by these viewers. For example, if a viewer downloads content, orders a product, or shares information with other users of the EPG services, a nominal fee and/or credit may be applied to the customer account, which may be stored in the billing information in storage device 124.

In accordance with exemplary embodiments, networks 106 include an IP-based network that transmits programming content from host system 102 to customers, such as content viewing device 104 via a broadband connection. Networks 106 may be implemented in a wireless fashion, e.g., using wireless protocols and technologies, such as WiFi, WiMax, etc.

Content viewing device 104 presents programming content for viewing to users of the EPG services. Content viewing device 104 may be any type of network-enabled device that is capable of presenting programming content to viewers. In exemplary embodiments, content viewing device 104 may be a high-definition television, a personal computer configured to receive broadcast television, a portable computing device (e.g., personal digital assistant), a digital music player (e.g., MP3 player), cellular telephone (e.g., a 3G cell phone), other well-known viewing devices, etc.

Content viewing device 104 may include auxiliary devices, such as a set top box 108, digital video record (DVR) 110, messaging software 114, a media center (not shown) and a remote control (not shown). One or more of these devices may be implemented as separate elements or may be incorporated into the set top box 108. Set top box 108 provides a connection between the content viewing device 104 and external sources of signals, converting the signals into content that is displayed on a screen of the device 104. Where content viewing device 104 is an IP-enabled television, or IPTV device, set top box 108 includes a computer processor that provides bi-directional communications between networks 106 and the content viewing device 104 and decodes the video streaming media received as content programming and electronic programming information from host system 102. The remote control may include options (e.g., interface) enabled by the electronic programming guide services for selecting content for display or other activities, such as content filtering, content recording, content management, etc.

As indicated above, the digital video recorder (DVR) 110 may be communicatively coupled to content viewing device 104 either directly or as an integrated set top box/digital video recorder unit and records programming as configured by a user of the content viewing device 104. The programming may be recorded on a hard disk drive within the STB/DVR unit or on some suitable removable recording medium (e.g., digital video disk (DVD)).

As indicated above, content viewing device 104 includes a display screen 140 for viewing content provided by the host system 102. The display screen includes a primary panel 130 that displays current program content that has been selected by a viewer either directly or via EPG software. Current program content refers to programming that is currently airing and/or scheduled to air, and is presented at a designated time, as provided in an electronic programming guide. The display screen 140 of content viewing device 104 also includes an electronic programming guide panel 132 that provides information relating to current and future programming via the EPG software. As indicated above, the type of information that may be provided via the electronic programming guide, and displayed on electronic programming guide panel 132, includes program titles, primary actors/actresses, begin time, duration of program, a year in which the program was produced, and a brief text description of the program selected by the viewer via the electronic programming guide feature. In alternative embodiments, the electronic programming guide may be displayed entirely in the primary panel 130.

The display screen 140 of content viewing device 104 also includes one or more EPG service panels 134 that are embedded into the EPG software 112 via the EPG advertising application 118 as described further herein. As shown in the system of FIG. 1 for illustrative purposes, the EPG service panel 134 is integrated with the programming information presented in the electronic programming guide panel 132, as well as the primary panel 130. However, it will be understood that the EPG service panel 134 may be presented anywhere on the display screen 140 of content viewing device 104 (e.g., an additional panel (not shown) that is separate from the primary panel 130 and the electronic programming guide panel 132). The EPG advertising application 118 receives advertising or other related information from a variety of content sources (e.g., product or service advertisers, motion picture industry, television networks, Internet-based content providers, etc.).

In exemplary embodiments, the content collector 116 accesses advertisements stored in remote ads storage device 122. The auction engine 115 of the EPG advertising application 118 may be employed as an advertisement bidding tool whereby advertisers submit offers and desired advertisements for EPG placement. The auction engine 115 may receive advertisements from the content collector 116 as described herein. Thus, advertisers may bid to have their ads displayed in relation to certain programs being scrolled over or selected in the EPG. The community share module 119 may be used to provide communications services to EPG service users. For example, the community share module 119 may receive user requests via the EPG software 112 to share various content accessed in response to EPG activities conducted by the user. The communications services may be facilitated via the messaging application 114 and community share module 119. User requests may also include remote recording of content items listed in the EPG at other content viewing devices (e.g., friends and family). For example, using peer-to-peer or other similar networking methods, a user may be able to share that a particular program is airing tonight and suggest that a friend record that program on the friend's DVR, set top box, etc. In other embodiments, a first user may be given permission to set recordings on a second user's set top box, DVR, etc. and using networking methods the first user can set recordings for that second user. In one embodiment of the present invention, a network advertiser for a program may desire this community sharing so that the ratings for the program are increased. Incentives could be offered to the user in an embodiment of the invention so that for every community share user referred a certain discount or reward points are built up. These types of incentives can be offered in one or more of the EPG service panels 134. Also, incentives may be offered in the EPG service panels 134 for the user to record and/or view a particular program. For example, a user may be scrolling through a list of programs in the EPG and when a program with advertising content, such as “ER”, is scrolled over, then the EPG service panels 134 may be displayed offering incentives to the user if the user records and/or views that particular program. Thus, program content providers may be able to capture viewers that otherwise would simply skip over that program. The incentives can be discounts, reward points, coupons, credits, etc. and other well-known incentive mechanisms.

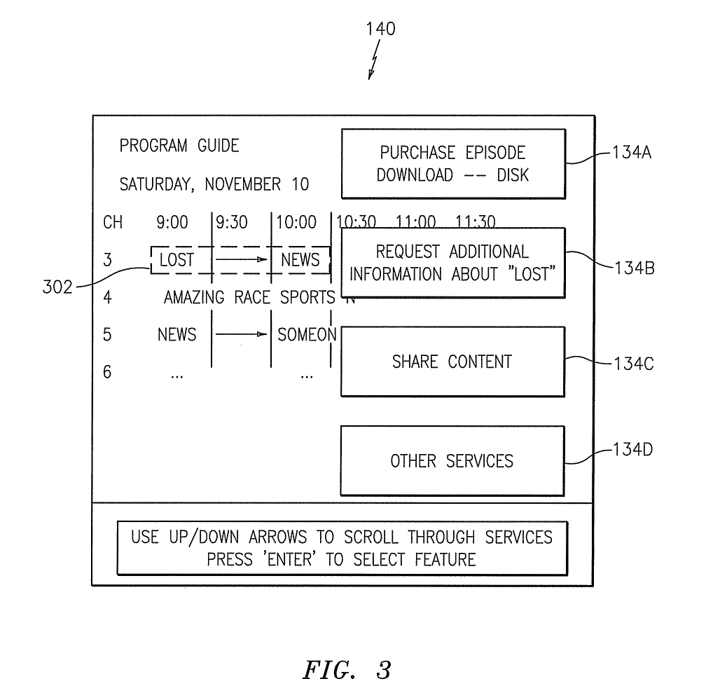

Turning now to FIG. 2, a flow diagram describing a process for implementing the EPG services will now be described in exemplary embodiments. The process begins at step 202 whereby the EPG software 112 is accessed by a user of content viewing device 104. The EPG advertising services application 118 monitors the viewer's activity conducted via the EPG software 112 either directly or via communication with the EPG software 112 at step 204. At step 206, it is determined whether the user has initiated an activity. Activities may include scanning/scrolling over a program listing in the EPG guide as presented on display screen 140, selecting a program to view, selecting a program to record, or other similar activity. A sample display screen 140 is shown in FIG. 3. As shown in FIG. 3, a user has highlighted a program (LOST) 302. If no activity has been detected at step 206, the process returns to step 204, whereby the user's activities continue to be monitored during the time the EPG software 112 is active on the content viewing device 104.

If, on the other hand, an activity is detected at step 206, the EPG advertising application 118 determines if an advertisement assignment exists for the selection at step 208. If so, the application 118 retrieves the advertisement (e.g., from remote ads in the storage device 122) at step 210 and instructs the EPG software 112 to insert the advertisement in the allotted panel 134 on the content viewing device 104 at step 212. As shown in FIG. 3, there are four EPG service panels 134A through 134D. Service panel 134A provides an advertisement directly related to the activity conducted by the viewer (e.g., the viewer highlights LOST and service panel 134A presents an offer to purchase the episode). It will be understood that the purchase offer presented in service panel 134A may be directed to non-program related items (e.g., viewers who are interested in LOST are generally between the ages of 18-25; advertisers who sell goods targeted for this audience may select this program for displaying their advertisements).

The service panel 134B, if selected by the viewer, enables the viewer to obtain additional information about the program. The service panel 134C enables the viewer to share specified content with other network entities (e.g., via messaging application 114 and community share module 119). The service panel 134D enables the viewer to obtain additional services. For example, additional services may include purchasing products or services associated with the highlighted content (e.g., t-shirts, ball caps, etc.). Although there are four service panels 134 shown in the exemplary embodiment, it will be understood by those skilled in the art that any number of panels may be displayed and that other display devices besides panels may be used such as banners, bubbles, drop down menus, etc. to display the advertising content.

At step 214, it is determined whether the user is finished perusing the EPG guide. For example, the user exits the EPG software 112 by either selecting a program to view or record, or by shutting down the EPG software 112. If not, the process returns to step 206 whereby the activities continue to be monitored. Otherwise, if the user is finished at step 214 then, depending upon the nature of activities conducted, a billing option may be initiated at step 216. For example, if the user chooses to download a program, purchase an advertised product/service, or share program information with another device user, there may be a fee and/or credit assessed against the customer's service account, whereby billing information/records in storage device 124 is updated to reflect the activity.

A profile record for the customer may be updated to reflect the activity conducted by the viewer at step 218. For example, the activities may include browsing program information in the EPG, selecting a program to view/record, invoking a request for additional information, product/service purchase, or communication with another viewing device.

Returning back to the step 208, if an ad assignment does not exist for the user, the EPG advertising application 118 checks to see if there is an ad candidate for display at step 220 (e.g., an advertisement stored in storage device 122 which has not been specifically assigned to a service panel, an advertisement that is determined through an auction process for the particular program or particular demographic group of the user, etc.). As indicated above, an advertisement candidate exists when the analytics component of the EPG advertising application 118 identifies an appropriate program and/or viewer placement for the advertisement.

If an ad candidate exists at step 222, the process returns to step 210 whereby the ad is retrieved (e.g., from remote ads in storage device 122 or from the STB 108). Otherwise, no further action is taken at step 224 and the EPG guide is presented using conventional means. It is determined whether the user is finished perusing the EPG at step 214. If not, the process returns to step 206. Otherwise, the billing component is optionally initiated at step 216, a profile record for the viewer is updated in storage device 120 to reflect the activity, and the process ends at step 226.

In some embodiments of the invention, the advertisements may include links to websites, offers to purchase items associated or not associated with the program selected, pay-per-view offers, enhanced feature offers (such as buy an extended version of this program, etc.), offers to share the program with others (via peer-to-peer networking, email alerts, instant messaging, record on another's DVR, etc.).

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. For example, embodiments of the invention may be used for program guides for other types of services such as satellite radio services, cellular services, wireless services, etc. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of providing interactive electronic programming guide (EPG) services, comprising:
determining an activity relating to a program listed on an EPG; and
upon determining that an advertisement exists for the program, retrieving the advertisement and instructing EPG software to insert the advertisement within an allotted advertisement space provided by the EPG software.

2. The method of claim 1, wherein the activity includes at least one of:
highlighting the program;
selecting the program for viewing; and
recording the program.

3. The method of claim 1, wherein determining that an advertisement exists for the program includes at least one of:
identifying whether an advertisement is assigned to the advertisement space; and
identifying a candidate advertisement using profile information when no advertisement is assigned to the advertisement space.

4. The method of claim 1, wherein the allotted advertisement space is embedded in content provided in at least one of a primary program panel and an EPG panel.

5. The method of claim 1, further comprising:
receiving a request to communicate content in the EPG software over a network; and
distributing the content to a network entity specified in the request.

6. The method of claim 1, wherein the advertisement is presented to a content viewing device that is Internet Protocol network-enabled and comprises at least one of a:
television;
personal computer;
personal digital assistant; and
cellular telephone.

7. The method of claim 1, further comprising:
receiving a request to purchase an item provided in the advertisement; and
submitting the request to a billing component associated with the EPG software.

8. A system for providing interactive electronic programming guide (EPG) services, comprising:
a host system; and
an electronic programming guide (EPG) advertising application executing on the host system, the EPG advertising application implementing a method, comprising:
determining an activity relating to a program listed on an EPG; and
upon determining that an advertisement exists for the program, retrieving the advertisement and instructing EPG software to insert the advertisement within an allotted advertisement space provided by the EPG software.

9. The system of claim 8, wherein the activity includes at least one of:
highlighting the program;
selecting the program for viewing; and
recording the program.

10. The system of claim 8, wherein determining that an advertisement exists for the program includes at least one of:
identifying whether an advertisement is assigned to the advertisement space; and
identifying a candidate advertisement using profile information when no advertisement is assigned to the advertisement space.

11. The system of claim 8, wherein the allotted advertisement space is embedded in content provided in at least one of a primary program panel and an EPG panel.

12. The system of claim 8, wherein the EPG advertising application further performs:
receiving a request to communicate content in the EPG software over a network; and
distributing the content to a network entity specified in the request.

13. The system of claim 8, wherein the advertisement is presented to a content viewing device that is Internet Protocol network-enabled and comprises at least one of a:
television;
personal computer;
personal digital assistant; and
cellular telephone;
wherein the EPG advertising application further performs:
receiving a request to purchase an item provided in the advertisement; and
submitting the request to a billing component associated with the EPG software.

14. A computer program product for providing interactive electronic programming guide (EPG) services, the computer program product including instructions for causing a computer to implement a method, comprising:
determining an activity relating to a program listed on an EPG; and
upon determining that an advertisement exists for the program, retrieving the advertisement and instructing EPG software to insert the advertisement within an allotted advertisement space provided by the EPG software.

15. The computer program product of claim 14, wherein the activity includes at least one of:
highlighting the program;
selecting the program for viewing; and
recording the program.

16. The computer program product of claim 14, wherein determining that an advertisement exists for the program includes at least one of:
identifying whether an advertisement is assigned to the advertisement space; and
identifying a candidate advertisement using profile information when no advertisement is assigned to the advertisement space.

17. The computer program product of claim 14, wherein the allotted advertisement space is embedded in content provided in at least one of a primary program panel and an EPG panel.

18. The computer program product of claim 14, further comprising instructions for implementing:
receiving a request to communicate content in the EPG software over a network; and
distributing the content to a network entity specified in the request.

19. The computer program product of claim 14, wherein the advertisement is presented to a content viewing device that is Internet Protocol network-enabled and comprises at least one of a:
television;
personal computer;
personal digital assistant; and
cellular telephone.

20. The computer program product of claim 14, further comprising instructions for implementing:
receiving a request to purchase an item provided in the advertisement; and
submitting the request to a billing component associated with the EPG software.
